(19) United States
(12) Patent Application Publication
(10) Pub. No.: US 2021/0004016 A1
(43) Pub. Date: Jan. 7, 2021

(54) U-TURN CONTROL SYSTEM FOR AUTONOMOUS VEHICLE AND METHOD THEREFOR

(71) Applicants: Hyundai Motor Company, Seoul (KR); Kia Motors Corporation, Seoul (KR)

(72) Inventor: Tae Dong Oh, Suwon (KR)

(21) Appl. No.: 16/591,233

(22) Filed: Oct. 2, 2019

(30) Foreign Application Priority Data
Jul. 4, 2019 (KR) 10-2019-0080539

(51) Int. Cl. G05D 1/02; B60W 30/045

(52) U.S. Cl. CPC G05D 1/0219; B60W 30/045; G05D 1/0223; G05D 1/0221

(57) ABSTRACT

A U-turn control system for an autonomous vehicle is provided. The U-turn control system includes a learning device that subdivides information regarding situations to be considered when the autonomous vehicle executes a U-turn for each of a plurality of groups and performs deep learning. A controller executes a U-turn of the autonomous vehicle based on the result learned by the learning device.

### CROSS-REFERENCE TO RELATED APPLICATION

This application is claims the benefit of priority to Korean Patent Application No. 10-2019-0080539, filed on Jul. 4, 2019, the entire contents of which are incorporated herein by reference.

### TECHNICAL FIELD

The present disclosure relates to technologies of determining a U-turn possibility for an autonomous based on deep learning, and more particularly, to a U-turn control system that subdivides information about various safe situations when the autonomous vehicle makes a U-turn to perform deep learning.

### BACKGROUND

In general, deep learning or a deep neural network is one type of machine learning. An artificial neural network (ANN) of several layers is configured between an input and an output. The ANN may include a convolutional neural network (CNN), a recurrent neural network (RNN), or the like depending on a structure thereof, problems to be solved, purposes, and the like. The deep learning is used to address various problems, for example, classification, regression, localization, detection, and segmentation. Particularly, in an autonomous system, semantic segmentation and object detection, capable of determining a location and type of a dynamic or static obstruction, are used.

The semantic segmentation refers to performing classification prediction on a pixel-by-pixel basis to detect an object in an image and segmenting the object for each pixel which has the same meaning. By semantic segmentation, whether a certain object exists in the image and locations of pixels may be verified, each of which has the same meaning (the same object), may be more accurately ascertained.

The object detection refers to classifying and predicting a type of an object in an image and performing regression prediction of a bounding box to fine location information of the object. By object detection, what a type of the object in the image is and location information of the object may be determined to be different from simple classification. A technology of determining whether it is possible for an autonomous vehicle to make a U-turn based on such deep learning has not been developed.

### SUMMARY

The present disclosure provides a U-turn control system for an autonomous vehicle to subdivide information regarding various situations to be considered for safety when the autonomous vehicle makes a U-turn to perform deep learning and determine whether it may be possible for the autonomous vehicle to make a U-turn based on the learned result to reduce an accident risk and a method therefor.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, an apparatus may include: a learning device that subdivides information regarding situations to be considered when the autonomous vehicle make a U-turn for each group and performs deep learning and a controller configured to execute a U-turn of the autonomous vehicle based on the result learned by the learning device. The U-turn controller may further include an input device configured to input data for each group regarding information about situations at a current time. The controller may be configured to determine whether it is possible for the autonomous vehicle to make a U-turn by applying the data input via the input device to the result learned by the learning device.

Additionally, the controller may be configured to determine whether it is possible for the autonomous vehicle to make a U-turn, in consideration of whether the autonomous vehicle obeys the traffic laws. The controller may also be configured to determine that it is possible for the autonomous vehicle to make the U-turn when a U-turn traffic light is turned on, when a U-turn sign on which the sentence ‘on U-turn signal’ is written is located in front of the autonomous vehicle.

The controller may be configured to determine that it is impossible for the autonomous vehicle to make the U-turn, when the autonomous vehicle is not located on a U-turn permitted area although a U-turn sign is located in front of the autonomous vehicle. The controller may further be configured to determine an area where the autonomous vehicle is located as the U-turn permitted area when a left line of a U-turn lane on which the autonomous vehicle is being driven is a broken dividing line and may be configured to determine the area where the autonomous vehicle is located as a U-turn prohibited area when the left line of the U-turn lane on which the autonomous vehicle is located is a continuous dividing line.

The input device may include at least one or more of a first data extractor configured to execute first group data for preventing a collision with a preceding vehicle which makes a U-turn in front of the autonomous vehicle as the autonomous vehicle makes a U-turn, a second data extractor configured to extract second group data for preventing a collision with a surrounding vehicle when the autonomous vehicle makes a U-turn, a third data extractor configured to extract third group data for preventing a collision with a pedestrian when the autonomous vehicle makes a U-turn, a fourth data extractor configured to extract a U-turn sign, located in front of the autonomous vehicle when the autonomous vehicle makes a U-turn, as fourth group data, a fifth data extractor configured to extract on-states of various traffic lights, located in front of the autonomous vehicle when the autonomous vehicle makes a U-turn, as fifth group data, a sixth data extractor configured to extract a drivable area based on the distribution of static objects, a drivable area based on a section of road construction, and a drivable area based on an accident section as sixth group data, a seventh data extractor configured to extract a drivable area based on a structure of a road as seventh group data, and an eighth data extractor configured to extract an area, where the drivable area extracted by the sixth data extractor and the drivable area extracted by the seventh data extractor are overlapped with each other, as eighth group data.

The first group data may include at least one or more of a traffic light on state, a yaw rate, or an accumulation value of longitudinal acceleration over time. The second group data may include at least one or more of a location, a speed, acceleration, a yaw rate, or a forward direction of the surrounding vehicle. The third group data may include at least one or more of a location, a speed, or a forward direction of the pedestrian or a detailed map around the pedestrian. The input device may further include a ninth data extractor configured to extract at least one or more of a speed, acceleration, a forward direction, a steering wheel angle, a yaw rate, or a failure code, which are behavior data of the autonomous vehicle, as ninth group data.

According to another aspect of the present disclosure, a method may include: subdividing, by a learning device, information regarding situations to be considered when the autonomous vehicle makes a U-turn for each group and performing, by the learning device, deep learning and executing, by a controller, a U-turn of the autonomous vehicle based on the result learned by the learning device.

The method may further include inputting, by an input device, data for each group about information regarding situations at a current time. The executing of the U-turn of the autonomous vehicle may include determining whether it is possible for the autonomous vehicle to make a U-turn by applying the input data to the result learned by the learning device. In addition, the executing of the U-turn of the autonomous vehicle may include determining whether it is possible for the autonomous vehicle to make a U-turn, in consideration of whether the autonomous vehicle obeys the traffic laws. The determination of whether it is possible for the autonomous vehicle to make the U-turn may include determining that it is possible for the autonomous vehicle to make the U-turn when a U-turn traffic light is turned on, when a U-turn sign on which the sentence ‘on U-turn signal’ is written is located in front of the autonomous vehicle.

However, the U-turn may be determined to be impossible when the autonomous vehicle is not located on a U-turn permitted area although a U-turn sign is located in front of the autonomous vehicle. The determination of whether it is possible for the autonomous vehicle to make the U-turn may further include determining an area where the autonomous vehicle is located as the U-turn permitted area, when a left line of a U-turn lane on which the autonomous vehicle is located is a broken dividing line and determining the area where the autonomous vehicle is located as a U-turn prohibited area, when the left line of the U-turn lane on which the autonomous vehicle is located is a continuous dividing line.

The inputting of the data for each group may include extracting first group data for preventing a collision with a preceding vehicle which makes a U-turn in front of the autonomous vehicle as the autonomous vehicle makes a U-turn, extracting second group data for preventing a collision with a surrounding vehicle when the autonomous vehicle makes a U-turn, extracting third group data for preventing a collision with a pedestrian when the autonomous vehicle makes a U-turn, extracting a U-turn sign, located in front of the autonomous vehicle when the autonomous vehicle makes a U-turn, as fourth group data, extracting on-states of various traffic lights, located in front of the autonomous vehicle when the autonomous vehicle makes a U-turn, as fifth group data, extracting a drivable area according to the distribution of static objects, a drivable area according to a section of road construction, and a drivable area according to an accident section as sixth group data, extracting a drivable area according to a structure of a road as seventh group data, and extracting an area, where the drivable area extracted by the sixth data extractor and the drivable area extracted by the seventh data extractor are overlapped with each other, as eighth group data.

The first group data may include at least one or more of a traffic light on state, a yaw rate, or an accumulation value of longitudinal acceleration over time. The second group data may include at least one or more of a location, a speed, acceleration, a yaw rate, or a forward direction of the surrounding vehicle. The third group data may include at least one or more of a location, a speed, or a forward direction of the pedestrian or a detailed map around the pedestrian. The inputting of the data for each group further may include extracting at least one or more of a speed, acceleration, a forward direction, a steering wheel angle, a yaw rate, or a failure code, which are behavior data of the autonomous vehicle, as ninth group data.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a configuration of a U-turn controller for an autonomous vehicle according to an exemplary embodiment of the present disclosure;

FIG. 2 is a block diagram illustrating a detailed configuration of a U-turn controller for an autonomous vehicle according to an exemplary embodiment of the present disclosure;

FIG. 3 is a drawing illustrating a situation where a first data extractor included in a U-turn controller for an autonomous vehicle extracts first group data according to an exemplary embodiment of the present disclosure;

FIGS. 4A, 4B, and 4C are drawings illustrating a situation where a second data extractor included in a U-turn controller for an autonomous vehicle extracts second group data according to an exemplary embodiment of the present disclosure;

FIGS. 5A, 5B, and 5C are drawings illustrating a situation where a third data extractor included in a U-turn controller for an autonomous vehicle extracts third group data according to an exemplary embodiment of the present disclosure;

FIG. 6 is a drawing illustrating a U-turn sign extracted as fourth group data by a fourth data extractor included in a U-turn controller for an autonomous vehicle according to an exemplary embodiment of the present disclosure;

FIG. 7 is a drawing illustrating a situation where a fifth data extractor included in a U-turn controller for an autonomous vehicle extracts a traffic light on state as fifth group data according to an exemplary embodiment of the present disclosure;

FIGS. 8A and 8B are drawings illustrating a drivable area extracted as sixth group data by a sixth data extractor included in a U-turn controller for an autonomous vehicle according to an exemplary embodiment of the present disclosure;

FIGS. 9A and 9B are drawings illustrating a drivable area extracted as seventh group data by a seventh data extractor included in a U-turn controller for an autonomous vehicle according to an exemplary embodiment of the present disclosure;

FIG. 10 is a drawing illustrating the final drivable area extracted as eighth group data by an eighth data extractor included in a U-turn controller for an autonomous vehicle according to an exemplary embodiment of the present disclosure;

FIGS. 11A and 11B are drawings illustrating a situation where a condition determining device included in a U-turn controller for an autonomous vehicle determines whether the autonomous vehicle obeys the traffic laws according to an exemplary embodiment of the present disclosure;

FIG. 12 is a flowchart illustrating a U-turn control method for an autonomous vehicle according to an exemplary embodiment of the present disclosure; and

FIG. 13 is a block diagram illustrating a computing system for executing a U-turn control method for an autonomous vehicle according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, some exemplary embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the exemplary embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

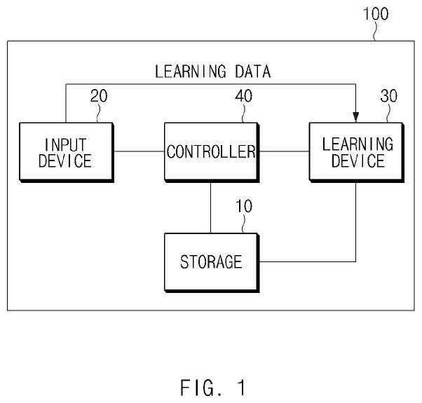

In an exemplary embodiment of the present disclosure, information may be used as the concept of including data. FIG. 1 is a block diagram illustrating a configuration of a U-turn controller for an autonomous vehicle according to an exemplary embodiment of the present disclosure. As shown in FIG. 1, a U-turn controller 100 for an autonomous vehicle according to an exemplary embodiment of the present disclosure may include a storage 10, an input device 20, a learning device 30, and a controller 40. In particular, the respective components may be combined with each other to form one component and some components may be omitted, depending on a manner which executes the U-turn controller 100 for the autonomous vehicle according to an exemplary embodiment of the present disclosure.

Seeing the respective components, first of all, the storage 10 may be configured to store various logics, algorithms, and programs which are required in a process of subdividing information about various situations to be considered for safety when the autonomous vehicle makes a U-turn for each group to perform deep learning and a process of determining whether it is possible for the autonomous vehicle to make a U-turn based on the learned result. The storage 10 may be configured to store the result learned by the learning device 30 (e.g., a learning model for a safe U-turn).

The storage 10 may include at least one type of storage medium, such as a flash memory type memory, a hard disk type memory, a micro type memory, a card type memory a secure digital (SD) card or an extreme digital (XD) card), a random access memory (RAM), a static RAM (SRAM), a read-only memory (ROM), a programmable ROM (PROM), an electrically erasable PROM (EEPROM), a magnetic RAM (MRAM), a magnetic disk, and an optical disk.

The input device 20 may be configured to input (provide) data (learning data) required in a process of learning a safe U-turn to the learning device 30. Furthermore, the input device 20 may be configured to perform a function of inputting data at a current time, which is required in a process of determining whether it is possible for the autonomous vehicle to make a U-turn, to the controller 40. The learning device 30 may be configured to learn data input via the input device 20 based on deep learning. In particular, the learning data may be in a format where information regarding various situations (e.g., scenarios or conditions) to be considered for safety when the autonomous vehicle makes a U-turn is subdivided for each group.

The learning device 30 may be configured to perform learning in various manners. For example, the learning device 30 may be configured to perform learning based on a simulation in the beginning when the learning is not performed (e.g., prior to the start of learning), perform the learning based on a cloud server in the middle when the learning is performed to some degree (e.g., after learning has started), and perform additional learning based on a personal U-turn tendency after the learning is completed. In particular, the cloud server may be configured to collect information regarding various situations from a plurality of vehicles, each of which makes a U-turn, and infrastructures and may be configured to provide the collected situation information as learning data to the autonomous vehicle.

The controller 40 may be configured to execute overall control to operate the respective components to perform respective functions. The controller 40 may be implemented in the form of hardware or software or in the form of a combination thereof. For example, the controller 40 may be implemented as, but not limited to, a microprocessor. Particularly, the controller 40 may be configured to perform a variety of control required in a process of subdividing information regarding various situations to be considered for safety when the autonomous vehicle makes a U-turn to perform deep learning and determining whether it is possible for the autonomous vehicle to make a U-turn based on the learned result.

The controller 40 may be configured to apply data regarding surroundings at a current time, input via the input device 20, to the result learned by the learning device 30 to determine whether it is possible for the autonomous vehicle to make a U-turn. When determining whether it is possible for the autonomous vehicle to make a U-turn, the controller 40 may further be configured to consider whether the autonomous vehicle obeys the traffic laws. In other words, although the result of applying the data regarding the surroundings at the current time, input via the input device 20, to the result learned by the learning device 30 indicates that it is possible for the autonomous vehicle to make the U-turn, the controller 40 may be configured to further determine whether the autonomous vehicle obeys the traffic laws to finally determine whether it is possible for the autonomous vehicle to make the U-turn.

For example, when a U-turn sign on which the phrase ‘on U-turn signal’ is written (or similar phrase indicated a U-turn signal) is located in front of the autonomous vehicle, although the result derived based on the result learned by the learning device 30 indicates that it is possible for the autonomous vehicle to make a U-turn, when a U-turn traffic light is not turned on, the controller 40 may be configured to determine that it is impossible for the autonomous vehicle to make or execute a U-turn. As another example, when a U-turn path of the autonomous vehicle is overlapped with a driving trajectory of a surrounding vehicle or within a constant distance from the driving trajectory of the surrounding vehicle, the controller 40 may be configured to determine that the surrounding vehicle will not yield to the autonomous vehicle and thus, determine that it is impossible for the autonomous vehicle to make a U-turn.

As yet another example, although a U-turn sign is located in front of the autonomous vehicle, when the autonomous vehicle is not located on a U-turn permitted area, the controller 40 may be configured to determine that it is impossible for the autonomous vehicle to make a U-turn. In particular, when a left road line (e.g., a line drawn on the road) of the autonomous vehicle located on a U-turn lane is a broken dividing line, the controller 40 may be configured to determine an area where the autonomous vehicle is located as a U-turn permitted area. However, when the left road line is a continuous dividing line, the controller 40 may be configured to determine the area where the autonomous vehicle is located as a U-turn prohibited area.

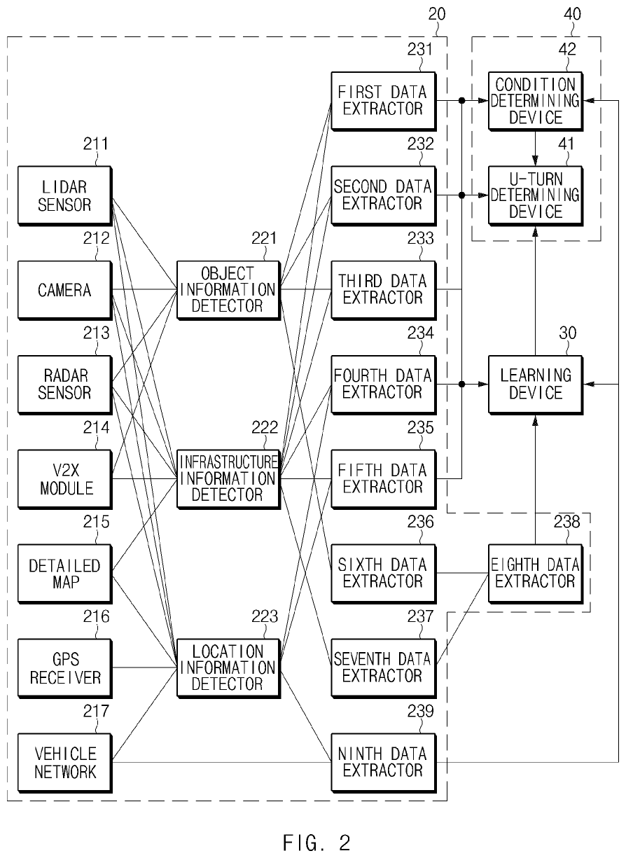

As shown in FIG. 2, an input device 20 may include a light detection and ranging (LiDAR) sensor 211, a camera 212, a radio detecting and ranging (radar) sensor 213, a vehicle-to-everything (V2X) module 214, a map 215, a global positioning system (GPS) receiver 216, and a vehicle network 217. The LiDAR sensor 211 may be one type of an environment sensor and may be configured to measure location coordinates of a reflector, or the like based on a time when a laser beam is reflected and returned after the reflector omni-directionally outputs the laser beam while mounted on an autonomous vehicle and rotated.

The camera 212 may be mounted on the rear of an indoor room mirror to capture an image including a lane, a vehicle, a person, or the like around the autonomous vehicle. The radar sensor 213 may be configured to receive electromagnetic waves reflected from an object after the electromagnetic waves are emitted to measure a distance from the object, a direction of the object, or the like. The radar sensor 213 may be mounted on a front bumper and a rear side of the autonomous vehicle, may be configured to perform long-distance object recognition. The radar sensor 13 may also be unaffected by weather.

The V2X module 214 may include a vehicle-to-vehicle (V2V) module (not shown) and a vehicle-to-infrastructure (V2I) module (not shown). The V2V module may be configured to communicate with a surrounding vehicle to obtain a location, a speed, acceleration, a yaw rate, a forward direction, or the like of the surrounding vehicle. The V2I module may be configured to obtain a form of a road, a surrounding structure, or information (e.g., a location or an on-state (red, yellow, green, or the like)) about a traffic light from an infrastructure.

The map 215 may be a detailed map for autonomous driving and may include information regarding a lane, a traffic light, or a sign to measure a location of the autonomous vehicle and enhance safety of autonomous driving. The GPS receiver 216 may be configured to receive a GPS signal from three or more GPS satellites. The vehicle network 217 may be a network for communication between respective controllers in the autonomous vehicle and may include a controller area network (CAN), a local interconnect network (LIN), FlexRay, media oriented systems transport (MOST), Ethernet, or the like.

Furthermore, the input device 20 may include an object information detector 221, an infrastructure information detector 222, and a location information detector 223. The object information detector 221 may be configured to detect object information around the autonomous vehicle based on the LiDAR sensor 211, the camera 212, the radar sensor 213, and the V2X module 214. In particular, the object may include a vehicle, a person, and an article or item located on the road. The object information may be information regarding the object and may include a speed, acceleration, or a yaw rate of the vehicle, an accumulation value of longitudinal acceleration over time, or the like.

The infrastructure information detector 222 may be configured to detect infrastructure information around the autonomous vehicle based on the LiDAR sensor 211, the camera 212, the radar sensor 213, the V2X module 214, and the detailed map 215. In particular, the infrastructure information may include a form (a lane, a median strip, or the like) of a road, a surrounding structure, a traffic light on state, a crosswalk outline, a road boundary, or the like. The location information detector 223 may be configured to detect location information of the autonomous vehicle based on the map 215, the GPS receiver 216, and the vehicle network 217. Furthermore, the input device 20 may include a first data extractor 231, a second data extractor 232, a third data extractor 233, a fourth data extractor 234, a fifth data extractor 235, a sixth data extractor 236, a seventh data extractor 237, an eighth data extractor 238, and a ninth data extractor 239.

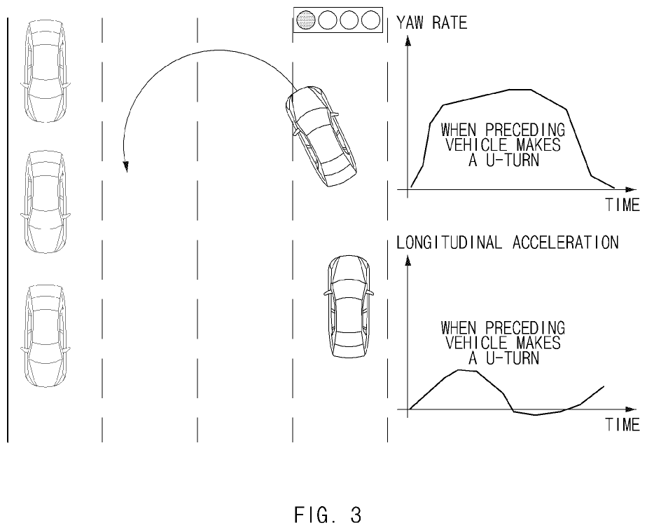

Hereinafter, a description will be given of a process of subdividing information regarding various situations to be considered for safety when the autonomous vehicle makes a U-turn for each of a plurality of data groups with reference to FIGS. 3 to 10.

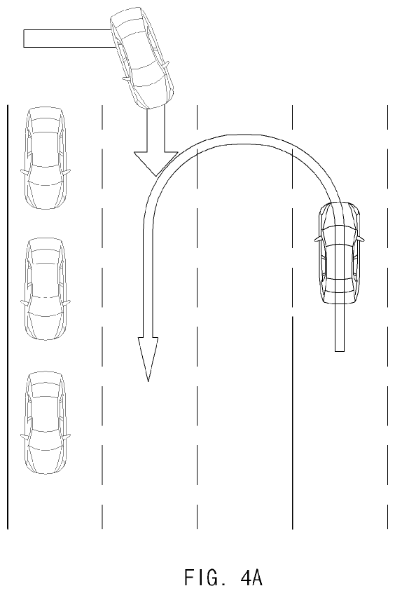

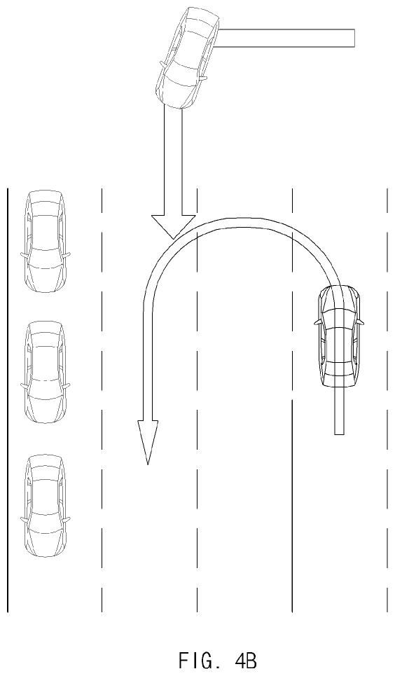

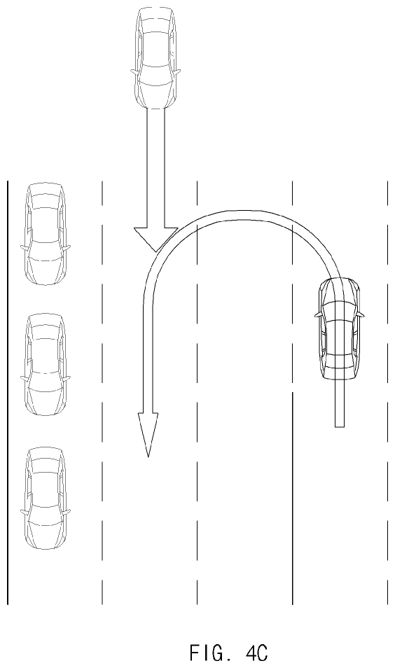

As shown in FIG. 3, the first data extractor 231 may be configured to extract first group data for preventing a collision with a preceding vehicle which first makes a U-turn in front of the autonomous vehicle as the autonomous vehicle makes a U-turn, from object information and infrastructure information. In particular, the first group data may be data associated with a behavior of the preceding vehicle and may include a traffic light on state, a yaw rate, or an accumulation value of longitudinal acceleration over time. As shown in FIGS. 4A to 4C, the second data extractor 232 may be configured to extract second group data for preventing a collision with a surrounding vehicle when the autonomous vehicle makes a U-turn, from object information and infrastructure information. In particular, the second group data may include a location, a speed, acceleration, a yaw rate, a forward direction, or the like of the surrounding vehicle.

FIG. 4A illustrates an occurrence of a collision with a surrounding vehicle which makes a right turn. FIG. 4B illustrates an occurrence of a collision with a surrounding vehicle which makes a left turn. FIG. 4C illustrates an occurrence of a collision with a surrounding vehicle traveling straight in the direction where an autonomous vehicle is located.

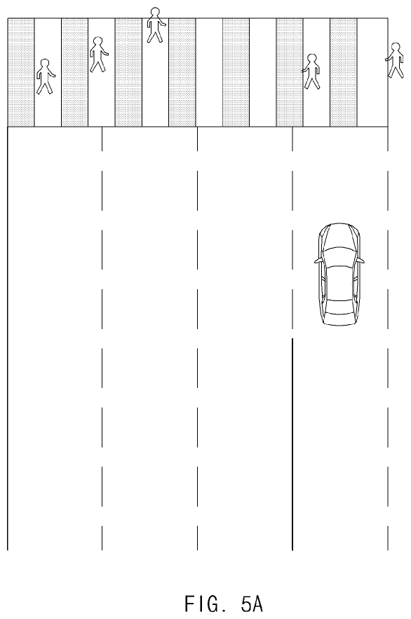

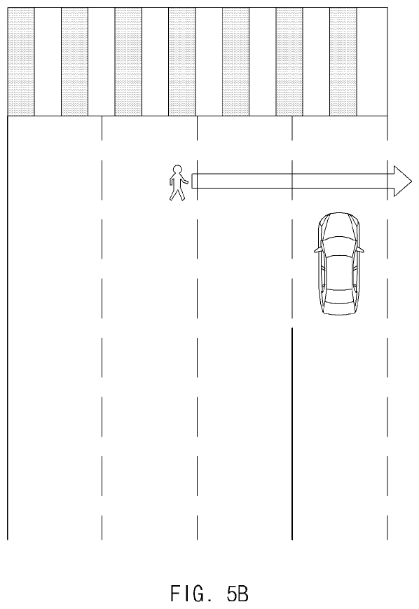

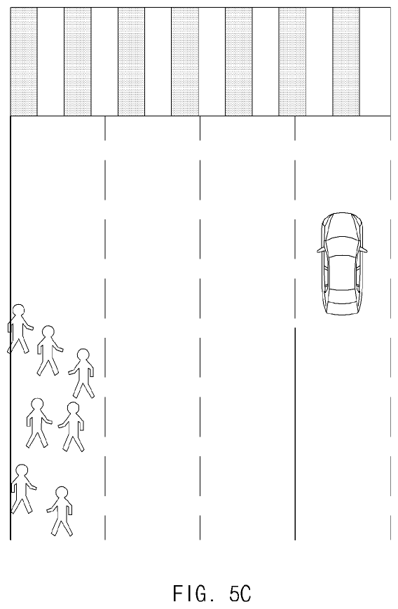

As shown in FIGS. 5A to 5C, the third data extractor 233 may be configured to extract third group data for preventing a collision with a pedestrian when an autonomous vehicle makes a U-turn, from object information and infrastructure information. In particular, the third group data may include a location, a speed, or a forward direction of the pedestrian, a detailed map around the pedestrian, or the like. FIG. 5A illustrates a case where a pedestrian walks on the crosswalk. FIG. 5B illustrates a case where a pedestrian crosses the road. FIG. 5C illustrates a case where pedestrians are stationary around a road boundary.

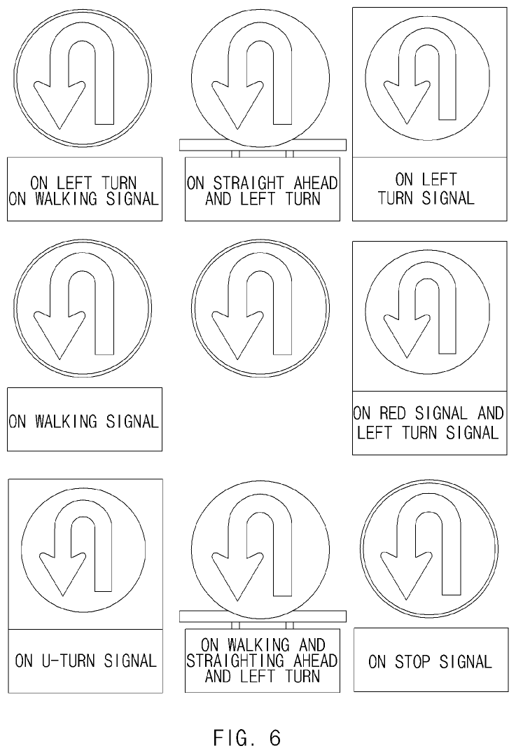

As shown in FIG. 6, the fourth data extractor 234 may be configured to extract various types of U-turn signs, located in front of an autonomous vehicle when the autonomous vehicle makes a U-turn, as fourth group data based on infrastructure information and location information. In particular, the U-turn signs may be classified into a U-turn sign on which there is a condition and a U-turn sign on which there is no condition. There are various conditions, such as ‘on walking signal’, ‘on stop signal’, ‘on U-turn signal’, and ‘on left turn’.

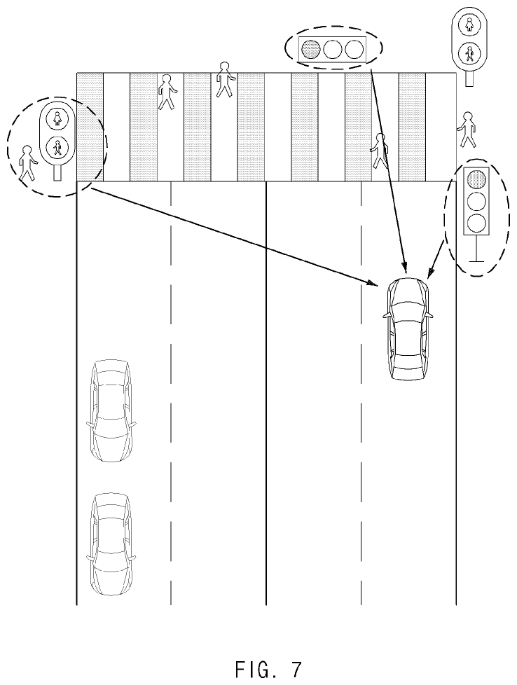

As shown in FIG. 7, the fifth data extractor 235 may be configured to detect on-states of respective traffic lights located around an autonomous vehicle, based on infrastructure information and location information, and extract an on-state of a traffic light associated with a U-turn of the autonomous vehicle among the obtained on-states of the respective traffic lights as fifth group data. In particular, the traffic lights may include a vehicle traffic light, a pedestrian traffic light, and the like, associated with the U-turn of the autonomous vehicle.

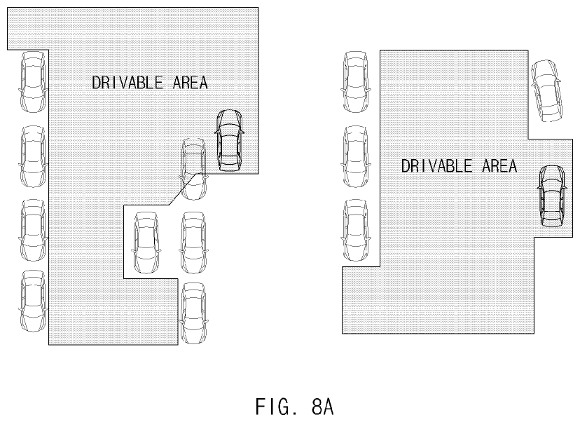

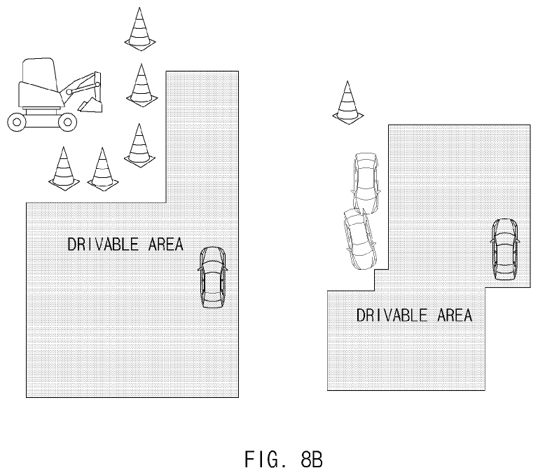

As shown in FIGS. 8A and 8B, the sixth data extractor 236 may be configured to extract a drivable area according to the distribution of static objects, a drivable area according to a section of road construction, and a drivable area according to an accident section as sixth group data based on object information. Herein, the drivable area may refer to an area on a lane opposite to a lane in which the autonomous vehicle is being driven. For example, when the autonomous vehicle is being driven in a lane from one direction to another direction, an opposite lane may refer to a lane from the other direction to the one direction. In other words, the autonomous vehicle may be driven from a first lane to a second lane and an opposite lane may refer to the vehicle being driven from a second lane to a first lane.

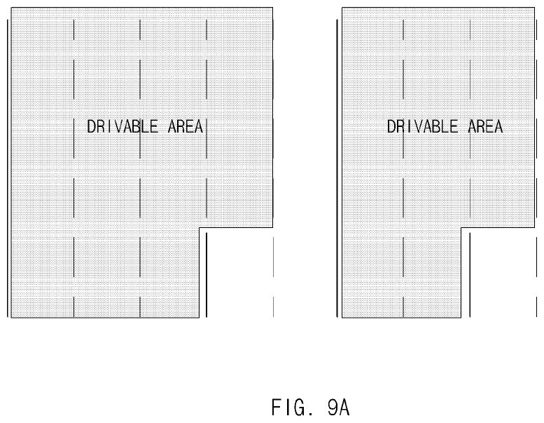

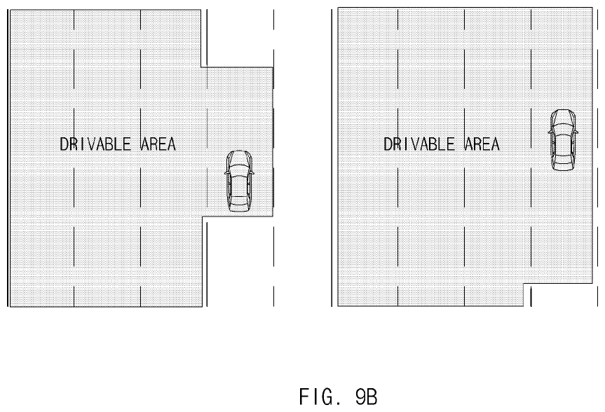

As shown in FIGS. 9A and 9B, the seventh data extractor 237 may be configured to extract a drivable area according to a structure of a road as seventh group data based on infrastructure information. In particular, the seventh data extractor 237 may be configured to extract a drivable area from an image captured by the camera 212 and extract a drivable area based on a location of an autonomous vehicle on the detailed map 215. The drivable area may refer to an area on a lane opposite to a lane where the autonomous vehicle is being driven.

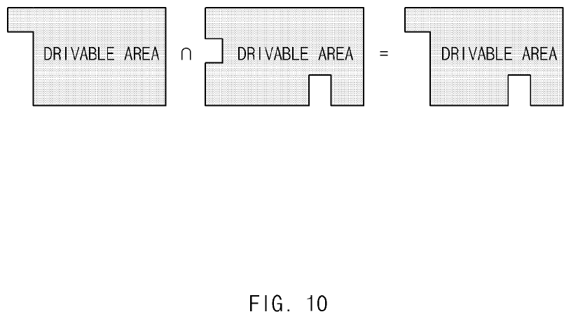

As shown in FIG. 10, the eighth data extractor 238 may be configured to extract an area (the final drivable area), where the drivable area extracted by the sixth data extractor 236 and the drivable area extracted by the seventh data extractor 237 are overlapped, as eighth group data.

The ninth data extractor 239 may be configured to extract a speed, acceleration, a forward direction, a steering wheel angle, a yaw rate, a failure code, or the like, which is behavior data of the autonomous vehicle, as ninth group data through location information and over the vehicle network 217. A learning device 30 may be configured to learn a situation where it is possible for the autonomous vehicle to make a U-turn, using the data extracted by the first data extractor 231, the data extracted by the second data extractor 232, the data extracted by the third data extractor 233, the data extracted by the fourth data extractor 234, the data extracted by the fifth data extractor 235, the data extracted by the eighth data extractor 238, and the data extracted by the ninth data extractor 239 based on deep learning.

The result learned by the learning device 30 may be used for a U-turn determining device 41 to determine whether it is possible for the autonomous vehicle to make or execute a U-turn. The learning device 30 may use at least one of a convolutional neural network (CNN), a recurrent neural network (RNN), a restricted Boltzmann machine (RBM), a deep belief network (DBN), deep Q-networks, a generative adversarial network (GAN), or softmax as an artificial neural network. In particular, at least 10 or more hidden layers of the artificial neural network may be used and about 500 or more hidden nodes may exist in the hidden layer. However, exemplary embodiments are not limited thereto.

A controller 40 may include the U-turn determining device 41 and a condition determining device 42 as function components thereof. The U-turn determining device 41 may be configured to apply the data extracted by the first data extractor 231, the data extracted by the second data extractor 232, the data extracted by the third data extractor 233, the data extracted by the fourth data extractor 234, the data extracted by the fifth data extractor 235, the data extracted by the eighth data extractor 238, and the data extracted by the ninth data extractor 239 to the result learned by the learning device 30 to determine whether it is possible for the autonomous vehicle to make a U-turn.

The U-turn determining device 41 may further consider the result determined by the condition determining device 42 to determine whether it is possible for the autonomous vehicle to make a U-turn. In other words, although it is primarily determined that it is possible for the autonomous vehicle to make a U-turn, when the result determined by the condition determining device 42 indicates violation of the traffic laws, the U-turn determining device 41 may be configured to finally determine that it is impossible for the autonomous vehicle to make a U-turn.

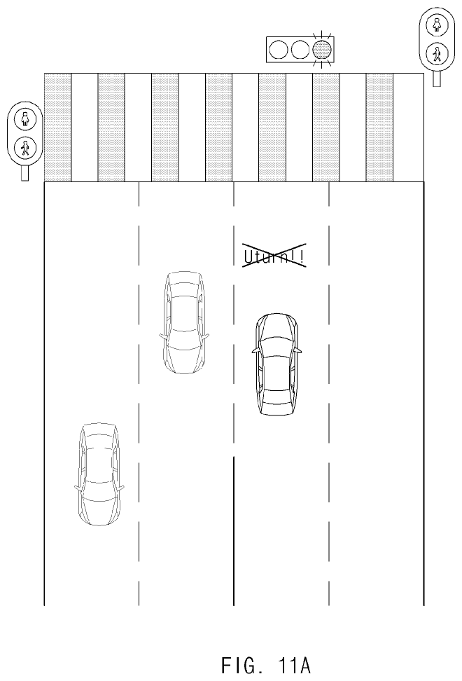

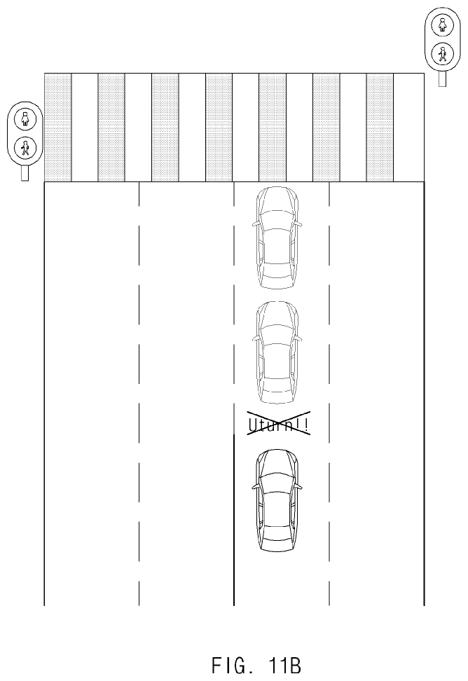

Further, the condition determining device 42 may be configured to determine whether the autonomous vehicle violates the traffic laws when the autonomous vehicle makes a U-turn, based on the data extracted by the first data extractor 231, the data extracted by the second data extractor 232, the data extracted by the third data extractor 233, the data extracted by the fourth data extractor 234, the data extracted by the fifth data extractor 235, the data extracted by the eighth data extractor 238, and the data extracted by the ninth data extractor 239. For example, as shown in FIG. 11A, when a U-turn sign on which the phrase ‘on U-turn signal’ is written is located in front of an autonomous vehicle, the condition determining device 42 may be configured to determine whether the autonomous vehicle violates the traffic laws, based on whether a U-turn traffic light is turned on. The U-turn sign may be an indication of when a U-turn is permitted (e.g., U-turn on red light or the like)

For another example, as shown in FIG. 11B, although a U-turn sign is located in front of an autonomous vehicle, the condition determining device 42 may be configured to determine whether the autonomous vehicle violates the traffic laws, based on a location of the autonomous vehicle. In particular, when a left road line of the autonomous vehicle on a U-turn lane is a broken dividing line, the condition determining device 42 may be configured to determine an area where the autonomous vehicle is located as a U-turn permitted area. When the left road line is a continuous dividing line, the condition determining device 42 may be configured to determine the area where the autonomous vehicle is located as a U-turn prohibited area.

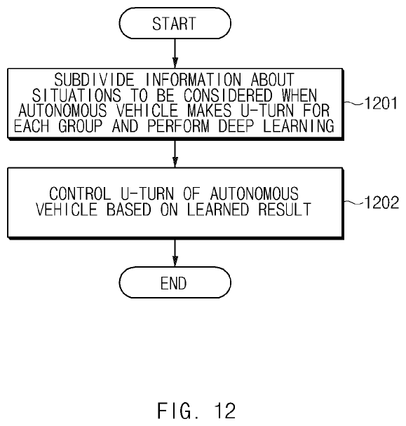

FIG. 12 is a flowchart illustrating a U-turn control method for an autonomous vehicle according to an exemplary embodiment of the present disclosure. First of all, in operation 1201, a learning device 30 of FIG. 1 may be configured to subdivide information regarding situations to be considered when an autonomous vehicle makes a U-turn for each group and may be configured to perform deep learning. In operation 1202, a controller 40 of FIG. 1 may be configured to operate a U-turn of the autonomous vehicle based on the result learned by the learning device 30.

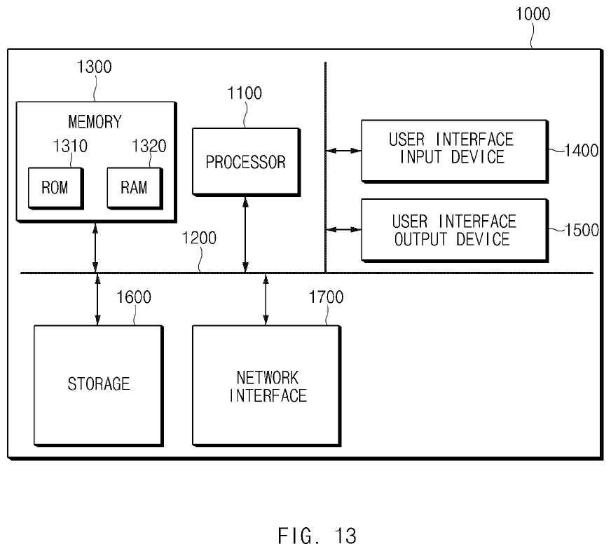

FIG. 13 is a block diagram illustrating a computing system for executing a U-turn control method for an autonomous vehicle according to an exemplary embodiment of the present disclosure. Referring to FIG. 13, the U-turn control method for the autonomous vehicle according to an exemplary embodiment of the present disclosure may be implemented by the computing system. The computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) and a RAM (Random Access Memory).

Thus, the operations of the method or the algorithm described in connection with the exemplary embodiments disclosed herein may be embodied directly in hardware or a software module executed by the processor 1100, or in a combination thereof. The software module may reside on a storage medium (e.g., the memory 1300 and/or the storage 1600) such as a RAM memory, a flash memory, a ROM memory, an EPROM memory, an EEPROM memory, a register, a hard disk, a removable disk, a CD-ROM. The exemplary storage medium may be coupled to the processor 1100, and the processor 1100 may read information out of the storage medium and may record information in the storage medium. Alternatively, the storage medium may be integrated with the processor 1100. The processor 1100 and the storage medium may reside in an application specific integrated circuit (ASIC). The ASIC may reside within a user terminal. In another case, the processor 1100 and the storage medium may reside in the user terminal as separate components.

The U-turn control system for the autonomous vehicle and the method therefor may subdivide information regarding various situations to be considered for safety when the autonomous vehicle makes a U-turn to perform deep learning and may determine whether it is possible for the autonomous vehicle to make a U-turn based on the learned result, thus considerably reducing an accident capable of occurring in the process where the autonomous vehicle makes the U-turn.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed based on the accompanying claims, and all the technical ideas within the scope equivalent to the claims should be included in the scope of the present disclosure.

What is claimed is:

1. A U-turn controller for an autonomous vehicle, comprising:
a learning device configured to subdivide information regarding situations to be considered when the autonomous vehicle executes a U-turn for each of a plurality of data groups and perform deep learning; and
a controller configured to execute a U-turn of the autonomous vehicle based on a result learned by the learning device.

2. The U-turn controller of claim 1, further comprising:
an input device configured to input data for each group about information regarding surroundings at a current time.

3. The U-turn controller of claim 2, wherein the controller is configured to determine whether it is possible for the autonomous vehicle to execute a U-turn by applying the data input via the input device to the result learned by the learning device.

4. The U-turn controller of claim 1, wherein the controller is configured to determine whether it is possible for the autonomous vehicle to makes a U-turn based on whether the autonomous vehicle obeys the traffic laws.

5. The U-turn controller of claim 4, wherein the controller is configured to determine that it is possible for the autonomous vehicle to execute the U-turn when a U-turn traffic light is turned on, when a U-turn sign is located in front of the autonomous vehicle.

6. The U-turn controller of claim 4, wherein the controller is configured to determine that it is impossible for the autonomous vehicle to execute the U-turn, when the autonomous vehicle is not located on a U-turn permitted area although a U-turn sign is located in front of the autonomous vehicle.

7. The U-turn controller of claim 6, wherein the controller is configured to determine an area where the autonomous vehicle is located as the U-turn permitted area when a left line of a U-turn lane on which the autonomous vehicle is being driven is a broken dividing line and determine the area where the autonomous vehicle is located as a U-turn prohibited area when the left line of the U-turn lane on which the autonomous vehicle is being driven is a continuous dividing line.

8. The U-turn controller of claim 2, wherein the input device includes at least one or more of:
a first data extractor configured to extract first group data for preventing a collision with a preceding vehicle executing a U-turn in front of the autonomous vehicle as the autonomous vehicle executes a U-turn;
a second data extractor configured to extract second group data for preventing a collision with a surrounding vehicle when the autonomous vehicle executes a U-turn;
a third data extractor configured to extract third group data for preventing a collision with a pedestrian when the autonomous vehicle executes a U-turn;
a fourth data extractor configured to extract a U-turn sign, located in front of the autonomous vehicle when the autonomous vehicle executes a U-turn, as fourth group data;
a fifth data extractor configured to extract on-states of various traffic lights, located in front of the autonomous vehicle when the autonomous vehicle executes a U-turn, as fifth group data;
a sixth data extractor configured to extract a drivable area according to the distribution of static objects, a drivable area according to a section of road construction, and a drivable area according to an accident section as sixth group data;
a seventh data extractor configured to extract a drivable area according to a structure of a road as seventh group data; and
an eighth data extractor configured to extract an area, where the drivable area extracted by the sixth data extractor and the drivable area extracted by the seventh data extractor are overlapped, as eighth group data.

9. The U-turn controller of claim 8, wherein the first group data includes at least one or more of a traffic light on state, a yaw rate, and an accumulation value of longitudinal acceleration over time, wherein the second group data includes at least one or more of a location, a speed, acceleration, a yaw rate, and a forward direction of the surrounding vehicle, and wherein the third group data includes at least one or more of a location, a speed, and a forward direction of the pedestrian or a map around the pedestrian.

10. The U-turn controller of claim 8, wherein the input device further includes:
a ninth data extractor configured to extract at least one or more of a speed, acceleration, a forward direction, a steering wheel angle, a yaw rate, or a failure code, which are behavior data of the autonomous vehicle, as ninth group data.

11. A U-turn control method for an autonomous vehicle, the method comprising:
subdividing, by a learning device, information regarding situations to be considered when the autonomous vehicle executes a U-turn for each of a plurality of groups and performing, by the learning device, deep learning; and
executing, by a controller, a U-turn of the autonomous vehicle based on a result learned by the learning device.

12. The method of claim 11, further comprising:
inputting, by an input device, data for each of the plurality of groups about information regarding surroundings at a current time.

13. The method of claim 12, wherein the executing of the U-turn of the autonomous vehicle includes:
determining whether it is possible for the autonomous vehicle to execute a U-turn by applying the input data to the result learned by the learning device.

14. The method of claim 11, wherein the executing of the U-turn of the autonomous vehicle includes:
determining whether it is possible for the autonomous vehicle to execute a U-turn based on whether the autonomous vehicle obeys the traffic laws.

15. The method of claim 14, wherein the determining whether it is possible for the autonomous vehicle to execute the U-turn includes:
determining that it is possible for the autonomous vehicle to execute the U-turn when a U-turn traffic light is turned on, when a U-turn sign is located in front of the autonomous vehicle.

16. The method of claim 14, wherein the determining whether it is possible for the autonomous vehicle to execute the U-turn includes:
determining that it is impossible for the autonomous vehicle to execute the U-turn, when the autonomous vehicle is not located on a U-turn permitted area although a U-turn sign is located in front of the autonomous vehicle.

17. The method of claim 16, wherein the determining whether it is possible for the autonomous vehicle to execute the U-turn includes:
determining an area where the autonomous vehicle is located as the U-turn permitted area, when a left line of a U-turn lane on which the autonomous vehicle is being driven is a broken dividing line; and
determining the area where the autonomous vehicle is located as a U-turn prohibited area, when the left line of the U-turn lane on which the autonomous vehicle is being driven is a continuous dividing line.

18. The method of claim 12, wherein the inputting of the data for each of the plurality of groups includes:
extracting first group data for preventing a collision with a preceding vehicle which executes a U-turn in front of the autonomous vehicle as the autonomous vehicle executes a U-turn;
extracting second group data for preventing a collision with a surrounding vehicle when the autonomous vehicle executes a U-turn;
extracting third group data for preventing a collision with a pedestrian when the autonomous vehicle executes a U-turn;
extracting a U-turn sign, located in front of the autonomous vehicle when the autonomous vehicle executes a U-turn, as fourth group data;
extracting on-states of various traffic lights, located in front of the autonomous vehicle when the autonomous vehicle executes a U-turn, as fifth group data;
extracting a drivable area according to the distribution of static objects, a drivable area according to a section of road construction, and a drivable area according to an accident section as sixth group data;
extracting a drivable area according to a structure of a road as seventh group data; and
extracting an area, where the drivable area extracted by the sixth data extractor and the drivable area extracted by the seventh data extractor are overlapped, as eighth group data.

19. The method of claim 18, wherein the first group data includes at least one or more of a traffic light on state, a yaw rate, and an accumulation value of longitudinal acceleration over time, wherein the second group data includes at least one or more of a location, a speed, acceleration, a yaw rate, and a forward direction of the surrounding vehicle, and wherein the third group data includes at least one or more of a location, a speed, and a forward direction of the pedestrian or a map around the pedestrian.

20. The method of claim 18, wherein the inputting of the data for each group further includes:
extracting at least one or more of a speed, acceleration, a forward direction, a steering wheel angle, a yaw rate, or a failure code, which are behavior data of the autonomous vehicle, as ninth group data.
